(19) United States
(12) Patent Application Publication
(10) Pub. No.: US 2012/0159338 A1
(43) Pub. Date: Jun. 21, 2012

(54) MEDIA NAVIGATION VIA PORTABLE NETWORKED DEVICE

(75) Inventors: Peter Mountanos, Redwood City, CA (US); Majd Bakar, San Jose, CA (US); Francis Tsui, Belmont, CA (US); David Sloo, Menlo Park, CA (US)

(73) Assignee: MICROSOFT CORPORATION, Redmond, WA (US)

(21) Appl. No.: 12/973,692

(22) Filed: Dec. 20, 2010

(51) Int. Cl. G06F 3/048; H04N 5/445; G06F 15/16

(52) U.S. Cl. 715/738; 725/39

(57) ABSTRACT

Embodiments are disclosed that relate to navigation in a media consumption environment. One embodiment provides, on a portable networked device, a method comprising receiving media metadata from a server via a network, wherein the media metadata corresponds to media content available for viewing. The method further comprises displaying on a display of the portable networked device a user interface presenting the media metadata, receiving a user input via the user interface selecting a media item, and in response, sending a request for the media item to a media rendering device.

### BACKGROUND

Remote controls may be used to interface with various types of electronic devices within an entertainment environment, including but not limited to media rendering devices such as set-top boxes, and media presentation devices such as televisions. In many cases, remote controls communicate with such devices wirelessly by sending signals via infrared or radio-frequency protocols.

Many remote controls may utilize a directional pad (D-pad) for thumb-operated directional control. In some cases, such operation may be used for navigating through a menu, such as an electronic programming guide displayed on a media presentation device such as a television. However, as programming guides evolve to include additional content such as text, images, etc. it may be cumbersome for a user to navigate such a user interface via traditional D-pad inputs.

### SUMMARY

Various embodiments are disclosed herein that relate, to user interface presentation and navigation via a portable networked device in a media consumption environment. For example, one disclosed embodiment provides, on a portable networked device, a method of selecting media for presentation via a media presentation device. The method comprises receiving media metadata from a server via a network, wherein the media metadata corresponds to media content available for viewing. The method further comprises displaying on a display of the portable networked device a user interface presenting the media metadata. The method further comprises receiving a user input via the user interface selecting a media item, and in response, sending a request for the media item to a media rendering device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example media consumption environment in accordance with an embodiment of the present disclosure.

FIG. 2 shows a flow diagram of an embodiment of a method of navigating and selecting a media item in a media consumption environment.

### DETAILED DESCRIPTION

Traditional remotes, such as those utilizing D-pad controls, may be well-suited for traditional electronic programming guides. However, as Internet protocol (IP)-based television platforms and other media consumption environments increase in functionality, a user interaction experience enabled by existing remotes may be somewhat limited. For example, navigating a rich user interface sequentially using a D-pad control may result in an undesirable user experience if the user finds it slow and/or frustrating to navigate, makes mistakes, or is otherwise unable to enjoy the full extent of the user interface. Additionally, applications which include search features, social media sites, text messaging, etc. may be difficult to use with text entry capabilities available via traditional remote controls, such as triple-tap methods of typing letters via a numerical keypad.

Therefore, embodiments are disclosed herein that relate to navigating in a media consumption environment via a user interface on a portable networked device, instead of on a media rendering or presentation device. The utilization of a portable networked device as a navigational remote control and a user interface presentation device may facilitate the use of rich user interfaces, as navigation by such a portable networked device may allow more direct navigation to a desired media content selection in a rich user interface than a traditional D-pad user input. Upon selection of a media item from the user interface displayed on the portable networked device, such selection may be sent to the media rendering device, which may request the transmission of the media item from the media server to the media rendering device.

Moving user interface navigation control from a media presentation device or a media rendering device to a portable networked device may enhance the media discovery experience in other ways. For example, a close-in user interface environment (a “two-foot” user experience, referring to an example distance between the displayed user interface and the user's eyes) may allow the use of a richer user interface than a traditional experience (a “ten-foot” user experience) in which the user interface is presented only on the display device. Moving the user interface presentation and navigation functionality to the handheld device also may allow a set-top box, television, or the like to have simplified functionality so as to merely render the media content for presentation, rather than also performing navigation-related tasks.

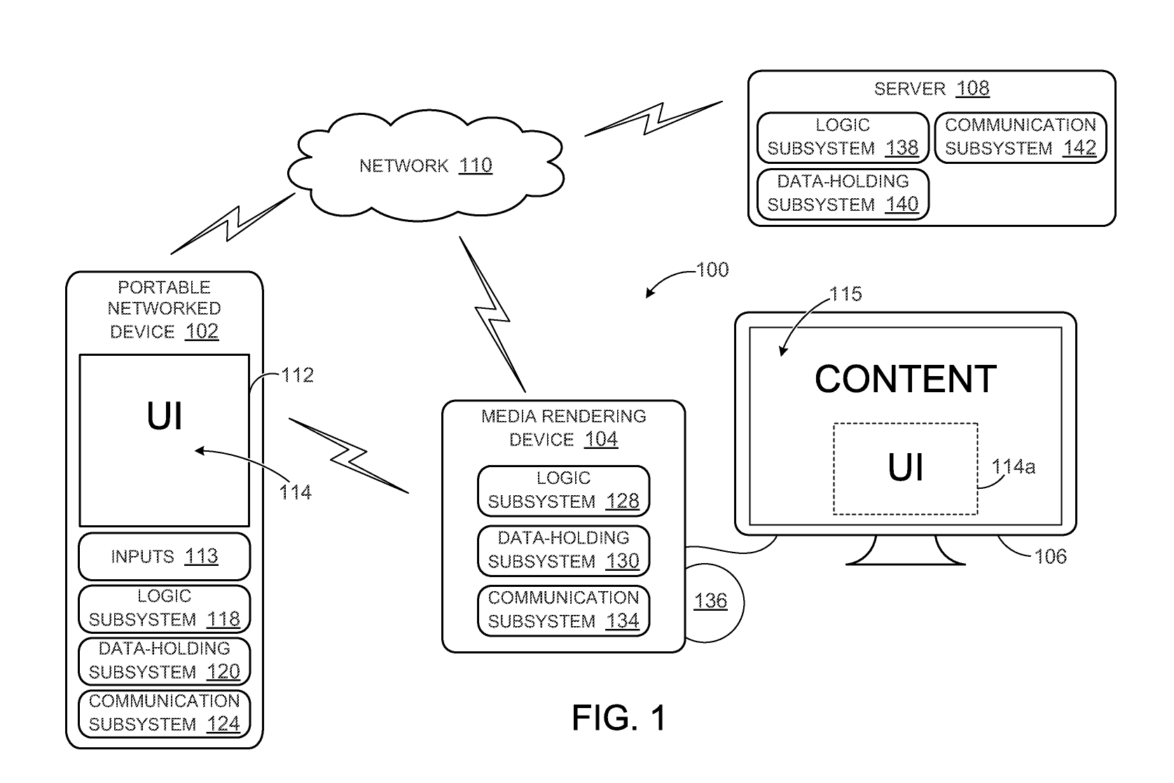

FIG. 1 shows an example media consumption environment 100 including a portable networked device 102 and a media rendering device 104. Portable networked device 102 may be any suitable portable computing device such as a mobile phone, a portable media player, a tablet computer, etc. The media rendering device is configured to render media for display on a media presentation device 106. Media rendering device 104 may be any suitable device configured to receive and render media content for display, including but not limited to a set-top box. Media rendering device 104 may be coupled to media presentation device 106 via any suitable video link, such as coaxial cable, a High-Definition Multimedia Interface (HDMI), or other suitable link. Further, in some embodiments, media rendering device 104 may be integrated with or otherwise incorporated into media presentation device 106.

Server 108 may be configured to provide media content to media rendering device 104 via a network 110, such as the Internet and/or an operator-managed network. Server 108 may be any suitable network-accessible server configured to provide media content, such as an Internet protocol television (IPTV) provider, a cable television provider, a satellite television provider, an on-demand content provider, an over-the-top (OTT) network content provider, etc. Further, server 108 may provide any suitable media content, such as television programming, video-on-demand, streamed content, etc. Server 108 may include one or more server devices communicatively coupled with one another.

Portable networked device 102 may include hardware instructions, software instructions, firmware instructions, and/or other machine-readable executable instructions to remotely interact with media rendering device 104 and server 108 to control the selection and presentation of media content. In some embodiments, portable networked device 102 may be further configured to control additional components of an entertainment system, such as media presentation device 106.

Portable networked device 102 includes a display 112 for displaying a user interface. Such a user interface may be used to display available media content to a user of the portable networked device 102. Portable networked device 102 also may include various user input devices 113, such as buttons, touch interfaces, and the like, that provide a rich input set to allow a user to interact with a displayed user interface 114 via touch, gestures, button presses, and/or any other suitable manner. As such, portable networked device 102 is configured to receive from server 108 media metadata corresponding to media items available for viewing, and to display a representation of the media metadata on a user interface for selection by the user. Portable networked device 102 may be any suitable device, including but not limited to a smart phone, portable media player, dedicated remote control device, tablet computer, notebook computer, notepad computer, or other portable device having a display.

Portable networked device 102 may communicate with server 108 via any suitable communication protocol, such as an Internet protocol. As a nonlimiting example, the user interface displayed on display 112 may include an electronic programming guide. It will be understood that the media metadata presented on the user interface may be received from a same server from which a selected media item is received, or from a different server.

As an example use scenario, a user may send a request from portable networked device 102 to server 108 to retrieve an electronic programming guide or other listing of media available for viewing from one or more media content sources. Server 108 then sends media metadata representing the available content, which is displayed on user interface 114. The user may then select a desired media item displayed user interface 114, for example, via a touch or gesture-based input. Upon receipt of the user input, portable networked device 102 sends a request for the media item to media rendering device 104. Media rendering device 104 may then retrieve the requested content from server 108 or other network location for rendering and presentation by media presentation device 106, as indicated at 115.

Portable networked device 102 may be configured to communicate with media rendering device 104 via any suitable hardware and/or protocol. In some cases, the protocol utilized for communications between portable networked device 102 and media rendering device 104 may be different from that utilized for communication between portable networked device 102 and server 108. The second communication protocol may be, for example, an infrared protocol, a radio-frequency protocol, a Bluetooth protocol, etc. In other embodiments, the same protocol may be used for portable networked device/server communications as for portable networked device/media rendering device communications. For example, portable networked device 102 may be configured to communicate with server 108 and media rendering device 104 via an Internet protocol.

In addition to the above-mentioned user input devices 113 and display 112, portable networked device 102 includes a logic subsystem 118, a data-holding subsystem 120, a display subsystem 122, and a communication subsystem 124. Logic subsystem 118 may include one or more physical devices configured to execute one or more instructions to perform the embodiments disclosed herein, among other tasks. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 118 may include one or more processors that are configured to execute software instructions. Additionally or alternatively, logic subsystem 118 may include one or more hardware or firmware logic machines configured to execute hardware or firmware instructions. Processors of logic subsystem 118 may be single core or multicore, and the programs executed thereon may be configured for parallel or distributed processing. Logic subsystem 118 may optionally include individual components that are distributed throughout two or more devices, which may be remotely located and/or configured for coordinated processing. One or more aspects of logic subsystem 118 may be virtualized and executed by remotely accessible networked computing devices configured in a cloud computing configuration.

Data-holding subsystem 120 may include one or more physical, non-transitory, devices configured to hold data and/or instructions executable by the logic subsystem to implement the herein described methods and processes. When such methods and processes are implemented, the state of data-holding subsystem 120 may be transformed (e.g., to hold different data).

Data-holding subsystem 120 may include removable media and/or built-in devices. Data-holding subsystem 120 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 120 may include devices with one or more of the following characteristics: volatile, nonvolatile, dynamic, static, read/write, read-only, random access, sequential access, location addressable, file addressable, and content addressable. In some embodiments, logic subsystem 118 and data-holding subsystem 120 may be integrated into one or more common devices, such as an application specific integrated circuit or a system on a chip.

Communication subsystem 124 may be configured to communicatively couple portable networked device 102 with one or more other computing devices, such as server 108 and/or media rendering device 104. Communication subsystem 124 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow portable networked device 102 to send and/or receive messages to and/or from other devices via a network such as the Internet, via personal area network protocols such as Bluetooth, via non-network protocols such as infrared or wireless protocols used by conventional television remote controls, and/or via any other suitable protocol and associated hardware.

Media rendering device 104 also includes a logic subsystem 128, a data-holding subsystem 130, and a communication subsystem 134. As introduced above with respect to portable networked device 102, logic subsystem 128 may be configured to execute instructions stored in data-holding subsystem 130 to perform the various embodiments of methods disclosed herein, among other tasks. Further, as introduced above with respect to portable networked device 102, communication subsystem 134 may be configured to communicatively couple media rendering device 104 with one or more other computing devices, such as server 108 and/or portable networked device 102. Communication subsystem 134 may include wired and/or wireless communication devices compatible with one or more communication protocols.

FIG. 1 also shows an aspect of the data-holding subsystem in the form of removable computer-readable storage media 136, which may be used to store and/or transfer data and/or instructions executable to implement the herein described methods and processes. Removable computer-readable storage media 136 may take the form of CDs, DVDs, HD-DVDs, Blu-Ray Discs, EEPROMs, and/or floppy disks, among others. While shown in FIG. 1 in the context of media rendering device 104, it will be understood that removable computer-readable storage media also may be used with portable networked device 102, server 108, and even media presentation device 106 in some instances.

Server 108 is also depicted as including a logic subsystem 138 stored on a data-holding subsystem 140. Server 108 may further include a communication subsystem 142 configured to communicatively couple server 108 with one or more other computing devices, such as portable networked device 102 and media rendering device 104.

As mentioned above, the media consumption environment 100 as illustrated in FIG. 1 decouples the navigation and the user interface presentation from the video processing at the media rendering device 104, and instead enables these functionalities at portable networked device 102. This is in contrast to traditional media consumption environments which typically utilize the same rendering device (e.g., a set-top box) to process audio and video, as well as control the navigation experience. Such traditional approaches not only place added functionality at the set-top box, but further, may limit user inputs via a remote control to those of D-pad navigation.

Decoupling navigation from video processing as illustrated at FIG. 1 allows for the functionality of media rendering device 104 to be simplified in comparison to that of traditional set-top boxes, so as to merely provide media rendering. Also, allowing portable networked device 102 to control the navigation experience leverages the full richness of its user interface, as well as its processing power, and its accessibility to the Internet. Further, having portable networked device 102 provide the navigation at display 112 may also afford a developer additional dimensions for developing a “two-foot user experience” that is far less constrained than traditional user experiences, and thus enriched with flexibility and ease in navigation.

In addition to responding to user input and displaying the user interface locally at display 112, portable networked device 102 may be further configured to relay markup instructions to media rendering device 104 or media presentation device 106 to cause the display of a reduced or similar user interface on media presentation device 106, as indicated at 114a. This may allow others in the same media consumption environment to share in the user experience by viewing user actions and system feedback. In this way, the richness of large screen display of the user interface may be provided, without being limited by the 10-foot user interface and D-pad-like navigation. It will be understood that the term “markup instructions” signifies any suitable set of instructions that specifies a visual appearance of a user interface to be rendered for display on media presentation device 106.

Any suitable protocol may be used for the transmission of the markup instructions from portable networked device 102 to media rendering device 104 or media presentation device 106. For example, in some embodiments, the same protocol may be used for the communication between portable networked device 102 and media device 104 as between portable networked device 102 and server 108. In other embodiments, the communication may utilize a legacy protocol, such as a one-way infrared protocol, to allow for the backward compatibility of legacy televisions and/or set-top boxes.

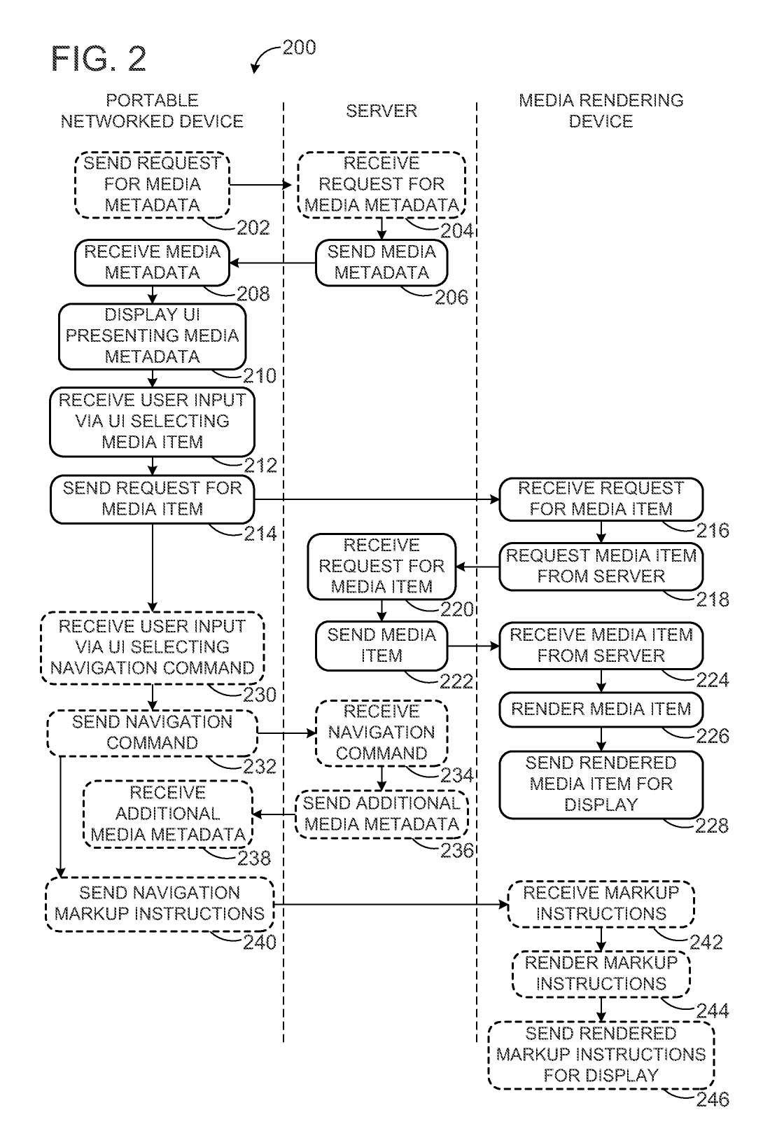

FIG. 2 illustrates a flow diagram 200 of an embodiment of a method of operating a media navigation and selection user interface on a portable networked device, and an embodiment of a method of providing a media experience based upon media selected via such a user interface. At 206, the server sends media metadata to the portable networked device via a network. The media metadata corresponds to media content available for viewing, such as television programming, video-on-demand, streamed content, etc. Then, at 208, the portable networked device receives the media metadata from the server over the network connection.

Upon receiving the media metadata, the portable networked device then displays a user interface presenting the media metadata on a display (e.g., display 112) of the portable networked device, as indicated at 210. Next, at 212, the portable networked device receives a user input selecting a media item displayed on the user interface. In response to receiving the user input, at 214, the portable networked device sends a request to the media rendering device to retrieve the media item from the server. Such a request may include any suitable information useable by the media rendering device to obtain the media item from the server. For example, in some embodiments, such a request may include an address at which the media rendering device can access the media item and/or an identification of the portable networked device sending the instruction. It will be appreciated that these examples are nonlimiting, and the request may include additional or alternative information without departing from the scope of this disclosure. Further, it will be understood that the media rendering device may be integrated into the media presentation device.

In some embodiments, communication between the portable networked device and the server occurs via a first protocol and communication between the portable networked device and the media rendering device occurs via a second, different protocol. For example, if the first communication protocol is an Internet protocol, the second communication protocol may be an infrared protocol, a radio-frequency protocol, a Bluetooth protocol, etc. In other cases, these communications may occur via the same protocol, as in the case where the portable networked device and the media rendering device are both networked and reside on a common Internet protocol network.

At 216, the media rendering device receives the instruction from the portable networked device to obtain the selected media item from the server. In response, the media rendering device requests the media item from the server, as indicated at 218. At 220, the server receives the request for the selected media item from the media rendering device via the network, and in response, sends the media item to the media rendering device, as indicated at 222. It should be appreciated that in some embodiments the server receiving the request and the server sending the media item may be different servers communicatively coupled with one another. It will be understood that the request sent to the server for the media item may include information identifying the requesting portable networked device. Alternatively, the server may store previously obtained information that associates the portable networked device with the media rendering device.

Continuing with FIG. 2, at 224, the media rendering device receives the media item from the server, and at 226, renders the media item for display to form a rendered media item. At 228, the media rendering device sends the rendered media item to a media presentation device for display. As nonlimiting examples, the media rendering device may send the rendered media item to the media presentation device via an HDMI connection, via a coaxial cable, or in any other suitable manner.

In some cases, a user may navigate through various nested levels or different screens of a user interface before discovering a media item for consumption. This is illustrated in FIG. 2 at 230, where the portable networked device receives a user input via the user interface selecting a navigation command. In such a case, the portable networked device may then send the navigation command to the server via the network (e.g., via the first communication protocol), as indicated at 232. At 234, the server receives the navigation command from the portable networked device via the network, and in response, at 236, sends additional media metadata to the portable networked device via the network, which is received by the portable networked device at 238. The additional media metadata represents new user interface content to which the user has navigated. It should be appreciated that the communication between the server and the portable networked device is not limited to metadata. For example, in some cases, a media item or some form of the media item (e.g., image thumbnails, video clips, etc.) may be returned to the portable networked device if the user experience may thereby be helped (e.g., aid in selection of an item for display on a television). Processes 230-238 may be performed repeatedly as a user navigates through a user interface until a media item is selected for consumption. Further, in some embodiments, communication between the media rendering device and the mobile device may be two-way. For example, the media rendering device may be configured to inform the portable networked device of its status, the status of the media item, and/or events that may provide useful information to the portable networked device.

As mentioned above, in some embodiments, the portable networked device may also send navigation markup instructions to the media rendering device (e.g., via the second communication protocol), as indicated at 240. The navigation markup instructions are configured to be rendered by the media rendering device to produce an image of a user interface for display so that other people in the same media consumption environment can enjoy the navigation and discovery experience. Accordingly, at 242, the media rendering device may receive navigation markup instructions from the portable networked device, and at 244, render the navigation markup instructions to produce an image of a user interface for display. At 246, the media rendering device may send the rendered markup to a media presentation device to display the image of the user interface. It will be understood that the navigation markup instructions may comprise any suitable information usable by the media rendering device to render the user interface for display.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a portable networked device, a method of selecting media for presentation on a media presentation device, the method comprising:
receiving media metadata from a server via a network, the media metadata corresponding to media content available for viewing;
displaying on a display of the portable networked device a user interface presenting the media metadata;
receiving a user input via the user interface selecting a media item; and
in response, sending a request for the media item to a media rendering device.

2. The method of claim 1, further comprising:
receiving a user input via the user interface selecting a navigation command;
sending the navigation command to the server via the network; and
responsive to the navigation command, receiving additional media metadata from the server via the network.

3. The method of claim 2, further comprising, responsive to the navigation command, sending navigation markup instructions to the media rendering device wherein the navigation markup instructions are configured to be rendered by the media rendering device to produce an image of a user interface for display.

4. The method of claim 1, wherein the request for the media item comprises an address at which the media rendering device can access the media item.

5. The method of claim 4, wherein the request for the media item further comprises an identification of the portable networked device.

6. The method of claim 1, wherein receiving media metadata from the server via the network comprises receiving the media metadata via a first communication protocol and wherein sending the request for the media item to the media rendering device comprises sending the request via a second communication protocol, the second communication protocol being different than the first communication protocol.

7. The method of claim 6, wherein the first communication protocol is an Internet protocol, and wherein the second communication protocol is an infrared protocol, a radio-frequency protocol, or a Bluetooth protocol.

8. The method of claim 1, wherein the portable networked device is a mobile communications device.

9. The method of claim 1, wherein the portable networked device is a computing device.

10. The method of claim 1, wherein the remote control device is a dedicated remote control.

11. A media rendering device, comprising:
a logic subsystem configured to execute instructions; and
a data-holding subsystem holding instructions executable by the logic subsystem to:
receive from a portable networked device a request for a media item provided by a network-accessible server, the request for the media item comprising an address at which the media item is accessible;
in response, request the media item from the network-accessible server;
receive the media item from the network-accessible server;
render the media item for display to form a rendered media item; and
send the rendered media item to a media presentation device for display.

12. The media rendering device of claim 11, wherein the instructions are further executable to receive navigation markup instructions from the portable networked device and render the navigation markup instructions to produce an image of a user interface for display.

13. The media rendering device of claim 11, wherein the instructions are executable to request the media item from the network-accessible server by sending a request for the media item via a first communication protocol, and to receive the request for the media item from the portable networked device by receiving the request via a second communication protocol, the second communication protocol being different than the first communication protocol.

14. The media rendering device of claim 11, wherein the first communication protocol is an Internet protocol, and wherein the second communication protocol is one of an infrared protocol, a radio-frequency protocol, and a Bluetooth protocol.

15. The media rendering device of claim 11, wherein the media rendering device is a set-top box.

16. On a network-accessible server, a method of providing a media experience, the method comprising:
receiving a request from a portable networked device for media metadata;
sending the media metadata to the portable networked device via a network, the media metadata corresponding to media content available for viewing;
receiving a request for a selected media item from a media rendering device via the network, the selected media item corresponding to the media metadata sent to the portable networked device; and
in response, sending the media item to the media rendering device.

17. The method of claim 16, further comprising receiving a navigation command from the portable networked device via the network, and in response, sending additional media metadata to the portable networked device via the network.

18. The method of claim 17, wherein the media metadata corresponds to an electronic programming guide for the media content available for viewing.

19. The method of claim 18, wherein the navigational command indicates a selection within a user interface of the electronic programming guide, and wherein sending additional media metadata includes sending an updated electronic programming guide.

20. The method of claim 16, wherein the media rendering device is a set-top box.
